(19) United States
(12) Patent Application Publication
(10) Pub. No.: US 2014/0273926 A1
(43) Pub. Date: Sep. 18, 2014

(54) Method and Apparatus for Handling Contacts

(71) Applicant: Magnus Wester, Stockholm (SE)

(72) Inventor: Magnus Wester, Stockholm (SE)

(73) Assignee: TELEFONAKTIEBOLAGET L M ERICSSON (PUBL), Stockholm (SE)

(21) Appl. No.: 14/352,002

(22) PCT Filed: Oct. 20, 2011
(86) PCT No.: PCT/EP2011/068307

§ 371 Date: Apr. 15, 2014

(51) Int. Cl. H04M 1/725; H04W 8/18

(52) U.S. Cl. CPC H04M 1/72586; H04M 1/72522; H04W 8/183
USPC 455/405; 455/564

(57) ABSTRACT

A method and apparatus in a user terminal (100) for handling contacts with which the user terminal has executed various amounts of communications. A weight is determined for the respective contacts based on obtained statistics of the communications, such that the weight reflects the extent of the communications with respective contact. A visual prominence is then assigned to the contacts depending on the weight and a control signal provided to a screen (100a) of the terminal causing the screen to display contacts (102) with relatively high weights with greater visual prominence than representations of contacts (104) with relatively low weights.

### TECHNICAL FIELD

The present disclosure relates generally to a method and an apparatus for conveniently handling contacts in a user terminal having a screen that can be controlled by a user.

### BACKGROUND

In user terminals for communication such as mobile phones, smartphones, tablets and personal computers, it is common to store and maintain contacts in alphabetical contact lists with entries for each contact including at least an identity of the contact such as a name, and a telephone number and/or e-mail address. A list of previously made calls or messages, typically the most recent ones, is also typically maintained in the terminal, and the alphabetical or recent call list can be retrieved and displayed on a screen of the terminal. A user of the terminal is then able to browse and search the contact list in order to find a particular contact and execute a communication with that contact, e.g. a call, session or a message. In this description, the term “contact” generally refers to a person and/or his user terminal.

Users most commonly browse the list of previously executed calls or messages first to easily find a searched contact, and then, if the contact is not found there, the alphabetical contact list may be browsed or the contact's name or telephone number may be entered. This can be a tedious and frustrating procedure, e.g. when the user has made many calls recently and the list of recently executed calls or messages is very long, or when the user does not exactly remember when the searched contact was last called. Hence, it may be tiresome for the user to search back in time through such a list of recent calls or messages. It may also happen that the user does not remember the name of the searched contact, making it quite difficult to find him in any contact list.

Further, if a communication is to be executed with more than one contact, e.g. for making a conference call or sending the same e-mail or SMS to plural contacts, each contact must be searched and selected at a time using the above contact lists, which may require some time-consuming efforts from the user, especially when not remembering the contact's name. Thus, to sum up, the current configuration and use of contact lists in user terminals often give rise to difficulties and require some effort by the user when searching for and selecting contacts to handle and execute communications.

### SUMMARY

It is an object of the invention to address at least some of the problems and issues outlined above. It is possible to achieve these objects and others by using a method and an apparatus as defined in the attached independent claims.

According to one aspect, a method is provided for handling contacts in a user terminal having a controllable screen, wherein the user terminal has executed communications with the contacts. In this method, the user terminal obtains statistics of the communications with respect to one or more of: amount of communications, duration, time since last communication and communication frequency. A weight is then determined for the respective contacts based on the obtained statistics. This weight reflects the extent of the communications that the user terminal has executed with each respective contact, such that the contacts are differentiated by their respective weights.

The user terminal also assigns a visual prominence to the contacts depending on their weight such that representations of contacts with relatively high weights are given greater visual prominence than representations of contacts with relatively low weights when displayed on the screen. A control signal is then provided that causes the screen to display the representations of the contacts with the assigned visual prominence of the respective contacts. In this way, a user of the terminal is able to search and find one or more contacts on the terminal without difficulty, in order to select the contact(s) for executing a communication or otherwise handling the contact(s) in the terminal.

According to another aspect, a user terminal is provided, configured for handling contacts with which the user terminal has executed communications. The user terminal comprises a controllable screen and an obtaining unit adapted to obtain statistics of the communications with respect to one or more of: amount of communications, duration, time since last communication and communication frequency. The user terminal also comprises a logic unit adapted to determine a weight for the respective contacts based on the obtained statistics, the weight reflecting the extent of the communications with respective contacts, and to assign a visual prominence to the contacts depending on the weight such that representations of contacts with relatively high weights are given greater visual prominence than representations of contacts with relatively low weights when displayed on the screen. The user terminal comprises a control unit adapted to provide a control signal causing the screen to display the representations of the contacts with the assigned visual prominence of the respective contacts.

The above method and user terminal may be configured and implemented according to different optional embodiments. In one possible embodiment, a command is received from a user selecting at least one of the contacts on the screen by the aid of the visual prominence of the displayed contacts, and communication with the selected at least one contact is handled in response to the received command. Handling the communication may, without limitation, include performing any of: initiating a call, initiating a message, initiating a multimedia session, and blocking of incoming calls for the selected at least one contact. Further, the received command may be a drag-and-drop command dragging the selected at least one contact to a field on the screen associated with one of the actions of initiating a call, initiating a message, initiating a multimedia session, and blocking of incoming calls.

In further possible embodiments, the obtained statistics of communications may pertain to at least one of: telephone calls, multimedia sessions, e-mails, instant messages, SMS messages, and MMS messages. The statistics of communications may be obtained from a local storage in the user terminal or from an access network having registered the executed communications.

In another possible embodiment, the statistics of communications are obtained for a time period determined by a command on the screen. The time period may be selected by the user in terms of length and dates, and in that case the control signal may be configured to cause the screen to display the representations of the contacts with respect to the selected time period. The assigned visual prominence of the respective contacts may relate to one or more of: size, vertical or horizontal position, closeness to screen centre, relative overlap level, brightness, colour, form, dimness and transparency.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIGS. 1-3 are schematic views illustrating a controllable screen of a user terminal, when used according to some possible embodiments.

FIG. 4 is a flow chart illustrating a procedure in a user terminal, according to further possible embodiments.

FIG. 5 is a block diagram illustrating a user terminal in more detail, according to further possible embodiments.

### DETAILED DESCRIPTION

Briefly described, a solution is provided to facilitate the handling of contacts in a user terminal having a controllable screen either using touch or mouse controlled commands. This solution enables the user to easily view and use representations of his/her contacts on the screen since different degrees of visual prominence are assigned to the contacts when displayed on the screen, to indicate how much communications each contact has made with the user terminal which in turn can be used as an indication of how significant or interesting the contact is to the user, e.g. for making future communications. In this context, the term “visual prominence” is used to indicate how strongly marked or salient a displayed representation of a contact, e.g. a picture of the contact, appears to a user when viewing the screen.

Contacts with which the user has communicated extensively will thus appear more prominently on the screen than other contacts with whom the user has communicated more rarely. Thereby, the user can easily and swiftly search and find one or more contacts on the terminal, e.g. for executing a communication or otherwise handling the contact(s) in the terminal. For example, the user can also more easily get a comprehensive overview of his contacts in this way to find and communicate with the more prominent contacts which are more likely to be communicated or handled by the user than other less prominent contacts.

In this description, “displaying a contact” actually means that a representation of the contact is displayed such as a picture, image, figure or symbol. In order to accomplish the above-described differentiation of prominence to the user's contacts when displayed on the screen, the user terminal first obtains statistics of previously executed communications with the contacts. These statistics may relate to one or more of: amount of communications, duration, time since last communication and communication frequency. The statistics may further be obtained for a specific selectable time period, which will be described in more detail later below. This type of information on previous communications may typically be continuously logged in the terminal or in an access network used for the communications, e.g. a mobile network, as the communications are executed.

The user terminal then determines a weight parameter for each of the contacts based on the obtained statistics such that the weight reflects the extent of communications made with the respective contact, e.g. during a certain time period. The extent of communications may be measured in different ways such as the number of calls, sessions or messages made, the total duration of calls and sessions, how often the contact was communicated, i.e. frequency, and so forth. More recent communications may also be given greater influence on the weight than communications made long ago. The weight parameter may be determined as any suitable numeric value reflecting the extent of communications, e.g. in the range of 0-1 or 0-100, such that contacts can be compared and/or estimated based on their weights.

Further, the above-described visual prominence is assigned to the contacts depending on the weight determined for the respective contacts, and a control signal is provided to the screen which causes the screen to display each contact with its assigned visual prominence. The “control signal” mentioned here may in practice include a plurality of signals or impulses that provide the described results when fed to the screen.

The above-discussed feature of visual prominence may be realized by means of different possible visual characteristics or properties. Without limiting the solution to the following examples, visual prominence in this context may relate to the size of the displayed contact, i.e. a high weight value results in a large image and vice versa. The assigned visual prominence may also relate to the contact's vertical or horizontal position on the screen, or closeness to screen centre, or to a relative overlap level of the contact, and/or its brightness, colour, form, dimness, transparency, and so forth. Two or more of the above-exemplified visual characteristics may further be combined in any suitable manner and the solution is not limited in this respect. Some possible embodiments and examples for putting the solution into practice will now be described and illustrated by the following figures.

FIG. 1 illustrates an example of how a screen 100a of a user terminal 100 may appear when using this solution. As explained above, the user terminal 100 has previously executed various amounts of communications with a set of contacts of which representations 102, 104 are displayed on the screen 100a. It is further assumed that the user terminal 100 has determined weights for the contacts, based on communication statistics, and assigned a visual prominence depending on their weights, in the manned outlined above. In this example, the contacts are given different visual prominence in terms of representation size such that, e.g., contact 102 is displayed on the screen 100a as a larger image than, e.g., contact 104, thus implying that contact 102 has greater weight than contact 104 as a result from having made communications with user terminal 100 to a greater extent than contact 104.

The screen 100a in the example of FIG. 1 also displays a set of functional buttons or fields 106 which can be activated, e.g. by a touch command or mouse command depending on the type of user terminal, for handling one or more selected contacts. In this example, the buttons or fields 106 can be activated for executing a call with field 106a, an SMS or MMs message with field 106b, an e-mail field with 106c, or an Instant Message, IM, with field 106d. A block field 106e is also shown that can be used for blocking a selected contact, i.e. effectively preventing the contact from communicating with the user terminal 100. In one possible usage indicated in the figure, a contact 102 can be selected as receiver to an e-mail by dragging and dropping the representation of contact 102 to the field for e-mail 106c, as indicated by a dashed arrow. It may also be possible to drag-and-drop several contacts at the same time to a functional field, thus activating the corresponding function for those contacts simultaneously, e.g. for sending the same e-mail to all selected contacts.

When the user makes such a drag-and-drop command for one or more selected contacts to one of the fields 106, the corresponding function is thus activated automatically for the selected contact(s). For example, a selected contact is automatically called or entered in a destination address field for an e-mail, or an SMS, MMS or IM message, or placed in a list of blocked contacts, and so forth.

FIG. 2 illustrates further possible examples of realizing the solution on the screen 100a of user terminal 100, where the visual prominence of some shown contacts relates to closeness to screen centre, e.g. a contact 202 having the greatest weight is accordingly located right at the centre, in contrast to contact 204 having less weight and being located away from the centre. Further, three of the shown contacts 206 are given different visual prominence in terms of relative overlap level when displayed, such that the foremost contact has the highest weight, etc.

The solution may be used according to further possible embodiments, as illustrated in FIG. 3. It was mentioned above that the statistics of executed communications may be obtained for a specific selectable time period. Thereby, the visual prominence assigned to the contacts is based on, and thus only valid for, the selected time period. In this way, the terminal user can control the statistic basis in a flexible manner for determining the weights that will influence the resulting visual prominence of displayed contacts. For example, the user may vaguely remember that a contact was frequently communicated a couple of times a year ago, and is able to find the contact on the screen by selecting a time period around a year ago. The communications made at that time will accordingly be included in the statistics used as a basis for determining the weight of that contact, who will then be displayed with corresponding visual prominence on the screen.

To realize the above features of the solution, the screen 100a in FIG. 3 may display a field 300, e.g. in the form of a strip or the like, having a time scale, in this case showing a range of calendar months: January, February, . . . and so forth. Alternatively, the time scale may show the number of days back in time, e.g. 10, 20, 30 days ago, and so forth.

The terminal user can select which time period to be used as the basis for determining the contact's weights, by moving a marking 302 along the scale in field 300, as indicated by two opposite arrows. Further, the marking 302 may also be expandable to change the length of the time period, as indicated by a dashed two-way arrow. Thereby, the terminal user can select both range and position of the time period for which the visual prominence of each displayed contact is valid. For example, if a touch sensitive screen is used, the marking 302 may be easily movable and expandable by manipulating the marking 302 by one or two fingers.

A procedure for handling contacts in a user terminal having a controllable screen, will now be described with reference to the flow chart in FIG. 3, illustrating actions executed in the user terminal. It is assumed that the user terminal has executed various communications with the contacts in the past, and that information on the executed communications has been logged either locally in the user terminal or in an access network serving the terminal, e.g. a mobile network in the case of a wireless user terminal.

In a first action 400, the user terminal obtains statistics of the executed communications with respect to one or more of: amount of communications, duration, time since last communication and communication frequency, as explained above. In this action, the user terminal may obtain statistics of communications executed during a selected time period, which may be selected by a user of the terminal e.g. in the manner described for FIG. 3 above. The user terminal further determines a weight for the respective contacts, in a following action 402, based on the obtained statistics, the weight reflecting the extent of the communications with respective contacts.

In a further action 404, the user terminal assigns a visual prominence to the contacts depending on their weights determined in action 402. The visual prominence is assigned in this action to each contact such that representations of contacts with relatively high weights are given greater visual prominence than representations of contacts with relatively low weights when displayed on the screen. Different possible examples of assigning different visual prominence to contacts have been described above with reference to FIGS. 1 and 2. The user terminal further provides a control signal, in a next action 406, causing the screen to display the representations of the contacts with the assigned visual prominence of the respective contacts.

Actions 400-406 above are thus performed by the user terminal automatically to provide for and enable differentiated visual appearance of the contacts on the screen as described above. The following actions in FIG. 4 are performed upon a user input or command as follows. A next action 408 thus illustrates that the user terminal receives a command from the user selecting at least one of the displayed contacts by the aid of the visual prominence of the displayed contacts. The received command may be a drag-and-drop command dragging the selected at least one contact to a field on the screen associated with one of the actions of initiating a call, initiating a message, initiating a multimedia session, and blocking of incoming calls.

In response to the received command, the user terminal basically handles communication with the selected at least one contact, in a last shown action 410. For example, handling the communication may include any of: initiating a call, initiating a message such as an SMS, MMS or IM message, initiating a multimedia session, and blocking of incoming calls for the selected at least one contact. Any conventional technique may be used for handling the communication as such, which is not necessary to describe here further to understand the solution.

A detailed but non-limiting example of how a user terminal can be configured to accomplish the above-described solution, is illustrated by the block diagram in FIG. 5. The user terminal 500 is configured for handling contacts with which the user terminal has executed communications, basically according to the procedure described above for FIG. 4. The user terminal 500 comprises a controllable screen 500a and an obtaining unit 500b, the latter being adapted to obtain statistics of the communications with respect to one or more of: amount of communications, duration, time since last communication and communication frequency.

The user terminal 500 further comprises a logic unit 500c adapted to determine a weight for the respective contacts based on the obtained statistics, the weight reflecting the extent of the communications with respective contacts. The logic unit 500c is also adapted to assign a visual prominence to the contacts depending on the weight, such that representations of contacts with relatively high weights are given greater visual prominence than representations of contacts with relatively low weights when displayed on the screen. The user terminal 500 further comprises a control unit 500e adapted to provide a control signal causing the screen 500a to display the representations of the contacts with the assigned visual prominence of the respective contacts.

It should be noted that FIG. 5 merely illustrates various functional units or entities in the user terminal 500 in a logical sense, although the skilled person is able to implement these functions in practice using suitable software and hardware means. Thus, this aspect of the solution is generally not limited to the shown structures of the user terminal 500, and the functional units 500b, d, e may be configured to operate according to the features described above for any of FIGS. 1-4, where appropriate.

The functional units 500b, d, e described above can be implemented in the user terminal 500 by means of program modules of a respective computer program comprising code means which, when run by a processor “P” causes the user terminal to perform the above-described actions. The processor P may be a single Central Processing Unit (CPU), or could comprise two or more processing units. For example, the processor P may include general purpose microprocessors, instruction set processors and/or related chips sets and/or special purpose microprocessors such as Application Specific Integrated Circuits (ASICs). The processor P may also comprise a storage for caching purposes.

Each computer program may be carried by a computer program product in the user terminal 500 in the form of a memory “M” connected to the processor P. The computer program product or memory M comprises a computer readable medium on which the computer program is stored. For example, the memory M may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the user terminal 500.

The above user terminal 500 and its functional units 500b, d, e may be configured or adapted to operate according to various optional embodiments. In one possible embodiment, when a command is received from a user selecting at least one of the contacts on the screen by the aid of the visual prominence of the displayed contacts, the control unit 500e may be further adapted to handle communication with the selected at least one contact in response to the command. The control unit 500e may further be adapted to handle the communication by performing any of: initiating a call, initiating a message, initiating a multimedia session, and blocking of incoming calls for the selected at least one contact.

In further possible embodiments, the obtaining unit 500b may further be adapted to obtain the statistics of communications from a local storage 500c in the user terminal or from an access network 502 having registered the executed communications. The obtaining unit 500b may also be adapted to obtain the statistics of communications for a time period determined by a command on the screen, e.g. the time period 302 illustrated in FIG. 3. As mentioned above, the time period may be selected by the user in terms of length and dates, and the control unit 500e is in that case adapted to configure the control signal to cause the screen to display the representations of the contacts with respect to the selected time period.

This solution thus allows the user to handle the contacts present in the user terminal in a convenient, lucid and swift manner. Since the representations of the contacts are displayed on the screen with differentiated visual prominence, the user can easily view and operate the contacts on the screen. As a result, the visual prominence can be used as an indication of how significant or “important” the contact is to the user, e.g. for executing further communications or for otherwise organizing the contacts in the terminal. For example, if the user has made extensive communications with a key contact in the past, the user will likely make further communications with that contact also in the future, which can be easily initiated when using this solution.

While the solution has been described with reference to specific exemplary embodiments, the description is generally only intended to illustrate the inventive concept and should not be taken as limiting the scope of the solution. For example, the terms “user terminal”, “communications”, “weight” and “visual prominence” have been used throughout this description, although any other corresponding nodes, actions, and/or parameters could also be used having the features and characteristics described here. The solution is defined by the appended claims.

1-18. (canceled)

19. A method of handling contacts in a user terminal having a controllable screen, wherein the user terminal has executed communications with the contacts, the method comprising:
obtaining statistics of said communications with respect to one or more of: amount of communications, duration, time since last communication and communication frequency;
determining weights for said respective contacts based on the obtained statistics, the weights reflecting the extent of said communications with respective contacts;
assigning a visual prominence to the contacts depending on said weights such that representations of contacts with relatively high weights are given greater visual prominence than representations of contacts with relatively low weights when displayed on the screen;
providing a control signal causing the screen to display the representations of said contacts with the assigned visual prominence of said respective contacts;
receiving a command from a user selecting at least one of said contacts on the screen by the aid of said visual prominence of the displayed contacts; and
handling communication with the selected at least one contact in response to said command.

20. The method according to claim 19, wherein handling the communication includes performing any of: initiating a call, initiating a message, initiating a multimedia session, and blocking of incoming calls for the selected at least one contact.

21. The method according to claim 20, wherein the received command is a drag-and-drop command dragging the selected at least one contact to a field on the screen associated with one of said actions of initiating a call, initiating a message, initiating a multimedia session, and blocking of incoming calls.

22. The method according to claim 19, wherein the statistics of said communications pertain to at least one of: telephone calls, multimedia sessions, e-mails, instant messages, SMS messages, and MMS messages.

23. The method according to claim 19, wherein the statistics of said communications are obtained from a local storage in the user terminal or from an access network having registered the executed communications.

24. The method according to claim 19, wherein the statistics of said communications are obtained for a time period determined by a command on the screen.

25. The method according to claim 24, wherein the time period is selected by the user in terms of length and dates, and said control signal is configured to cause the screen to display the representations of said contacts with respect to the selected time period.

26. The method according to claim 19, wherein the assigned visual prominence of said respective contacts relates to one or more of: size, vertical or horizontal position, closeness to screen center, relative overlap level, brightness, color, form, dimness and transparency.

27. A user terminal configured for handling contacts with which the user terminal has executed communications, comprising:
a controllable screen;
one or more processor circuits configured to:
obtain statistics of said communications with respect to one or more of: amount of communications, duration, time since last communication and communication frequency;
determine weights for said respective contacts based on the obtained statistics, the weights reflecting the extent of said communications with respective contacts, and to assign a visual prominence to the contacts depending on said weights such that representations of contacts with relatively high weights are given greater visual prominence than representations of contacts with relatively low weights when displayed on the screen, and
provide a control signal causing the screen to display the representations of said contacts with the assigned visual prominence of said respective contacts and wherein when a command is received from a user selecting at least one of said contacts on the screen by the aid of said visual prominence of the displayed contacts, the one or more processing circuits are further configured to handle communication with the selected at least one contact in response to said command.

28. The user terminal according to claim 27, wherein the one or more processing circuits are further adapted to handle the communication by performing any of: initiating a call, initiating a message, initiating a multimedia session, and blocking of incoming calls for the selected at least one contact.

29. The user terminal according to claim 28, wherein the one or more processing circuits are configured to receive the command as a drag-and-drop command corresponding to the user dragging the selected at least one contact to a field on the screen associated with one of said actions of initiating a call, initiating a message, initiating a multimedia session, and blocking of incoming calls.

30. The user terminal according to claim 27, wherein the statistics of said communications pertain to at least one of: telephone calls, multimedia sessions, e-mails, instant messages, SMS messages, and MMS messages.

31. The user terminal according to claim 27, wherein the one or more processing circuits are further adapted to obtain the statistics of said communications from a local storage in the user terminal or from an access network having registered the executed communications.

32. The user terminal according to claim 27, wherein the one or more processing circuits are is further adapted to obtain the statistics of said communications for a time period determined by a command on the screen.

33. The user terminal according to claim 32, wherein the time period is selected by the user in terms of length and dates, and the one or more processing circuits are further adapted to configure said control signal to cause the screen to display the representations of said contacts with respect to the selected time period.

34. The user terminal according to claim 27, wherein the assigned visual prominence of said respective contacts relates to one or more of: size, vertical or horizontal position, closeness to screen center, relative overlap level, brightness, color, form, dimness and transparency.

35. The user terminal according to claim 27, wherein the one or more processing circuits comprise an obtaining unit configured to obtain the statistics of said communications, a logic unit configured to determine the weights for said respective contacts and assign the visual prominence to the contacts depending on said weights, and a control unit configured to provide the control signal.
